(19) United States
(12) Patent Application Publication
(10) Pub. No.: US 2021/0224928 A1
(43) Pub. Date: Jul. 22, 2021

(54) SYSTEMS AND METHODS FOR PROVIDING A CHARGE CONSUMPTION ALERT

(71) Applicant: Honda Motor Co., Ltd., Tokyo (JP)

(72) Inventors: Eri Izumi Maeda, Rancho Palos Verdes, CA (US); David Wong Cun, Fountain Valley, CA (US)

(21) Appl. No.: 16/748,086

(22) Filed: Jan. 21, 2020

(51) Int. Cl. G06Q 50/06; G06Q 30/02

(52) U.S. Cl. CPC G06Q 50/06; G06Q 30/0255

(57) ABSTRACT

Systems and methods for providing a charge consumption alert are provided. In one embodiment, the system for a charge consumption alert includes a charge module, a threshold module, and an alert module. The charge module determines a first consumption value of a charge tier for a vehicle based on charge usage at a first location. The charge tier has an upper limit. The threshold module compares the first consumption value to a threshold value of the charge tier. The threshold value is based on the upper limit. The alert module generates an alert in response to determining that the first consumption value exceeds the threshold value. The alert includes an incentive to charge the vehicle at a second location different than the first location.

### BACKGROUND

Users of rechargeable vehicles typically charge their vehicles in the evenings, which increases the demand for electricity at that time. Given fluctuations in demand, the cost of electricity is typically charged in a tiered rate structure based on a consumption. The tiered rates increase the cost of energy based on usage and demand. Therefore, the user may pay a higher rate, associated with a higher tier, for the electricity to charge the vehicle if they develop a habit of charging in the evenings when demand is higher.

### BRIEF DESCRIPTION

According to one aspect, a system for providing a charge consumption alert is provided. The system includes a charge consumption alert includes a charge module, a threshold module, and an alert module. The charge module determines a first consumption value of a charge tier based on charge usage at a first location. The charge tier has an upper limit. The threshold module compares the first consumption value to a threshold value of the charge tier. The threshold value is based on the upper limit. The alert module generates an alert in response to determining that the first consumption value exceeds the threshold value. The alert includes an incentive to charge a vehicle at a second location different than the first location.

According to another aspect, a method for providing a charge consumption alert is provided. The method includes determining a first consumption value of a charge tier based on charge usage at a first location. The charge tier has an upper limit. The method also includes comparing the first consumption value to a threshold value of the charge tier. The threshold value is based on the upper limit. The method further includes generating an alert in response to determining that the first consumption value exceeds the threshold value. The alert includes an incentive to charge the vehicle at a second location different than the first location.

According to a further aspect, a non-transitory computer readable storage medium storing instructions that when executed by a computer, which includes a processor to perform a method for providing a charge consumption alert is provided. The method includes determining a first consumption value of a charge tier based on charge usage at a first location. The charge tier has an upper limit. The method also includes comparing the first consumption value to a threshold value of the charge tier. The threshold value is based on the upper limit. The method further includes generating an alert in response to determining that the first consumption value exceeds the threshold value. The alert includes an incentive to charge the vehicle at a second location different than the first location.

### BRIEF DESCRIPTION OF THE DRAWINGS

FIG. 1 is a schematic view of an exemplary traffic scenario on a roadway according to one embodiment.

FIG. 2 is a block diagram of an operating environment for providing a charge consumption alert according to an exemplary embodiment.

FIG. 3 is a process flow for providing a charge consumption alert according to one embodiment.

FIG. 4 is an exemplary charge architecture diagram for providing a charge consumption alert, according to one aspect.

FIG. 5 is an illustration of an example computer-readable medium or computer-readable device including processor-executable instructions configured to embody one or more of the provisions set forth herein, according to one aspect.

### DETAILED DESCRIPTION

As discussed above, charging rechargeable vehicles in the evening can exert a drain on the electrical grid and increase the user's rate based on a higher tier. However, the demand on the electrical grid and the tier are transparent to the user. For example, a user may not know how much energy that they have already consumed, or how much additional energy they can consume before being charged a higher rate associated with a higher tier. Accordingly, the user may be surprised by the cost of charging the vehicle.

The systems and methods described herein determine the user's current energy consumption at a first location. The energy consumption may be based on all energy consumed at the first location. Furthermore, the corresponding tier for the energy consumption may be determined based on the energy consumption. When the user exceed a predetermined threshold associated with the tier, the user is provided a charge consumption alert. The alert indicates that the user is approaching an upper limit for the corresponding tier. The alert may also indicate how much energy the user can consume before entering a higher tier. The alert may further include an incentive to charge the vehicle at a different location or time. For example, the alert may indicate as second location where a vehicle can be charged. In this manner, the user can be provided the information and/or incentive needed to change their charging habits.

### Definitions

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication,” as used herein, refers to a communication between two or more communicating devices (e.g., computer, personal digital assistant, cellular telephone, network device, vehicle, vehicle computing device, infrastructure device, roadside equipment) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface,” as used herein can include input and/or output devices for receiving input and/or devices for outputting data. The input and/or output can be for controlling different vehicle features, which include various vehicle components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface, which can be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk, data store, and/or a memory.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Display,” as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be accessible through various devices, for example, though a remote system. The display may also be physically located on a portable device, mobility device, or vehicle.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Operable connection,” or a connection by which entities are “operably connected,” is one in which signals, physical communications, and/or logical communications can be sent and/or received. An operable connection can include a wireless interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

A “user,” as used herein can include, but is not limited to, one or more biological beings exerting a demand on a source of energy, such as an electrical grid. The user can be a driver or a passenger of a vehicle.

“Value” and “level”, as used herein can include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

“Vehicle,” as used herein, refers to any moving vehicle that is capable of carrying one or more users and is powered by any form of energy. The term “vehicle” includes, but is not limited to, cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more users and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle can carry one or more users. Further, the term “vehicle” can include vehicles that are automated or non-automated with pre-determined paths or free-moving vehicles.

“Vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, an interior or exterior camera system among others.

### I. Systems Overview

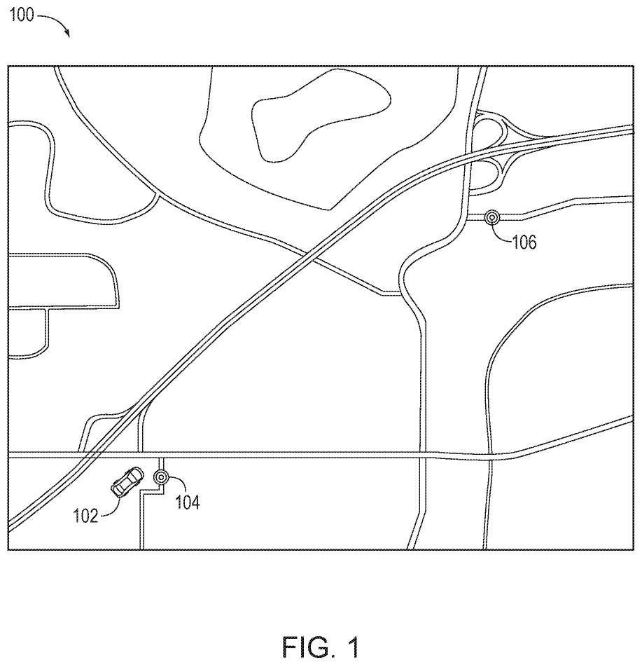

Referring now to the drawings, the showings are for purposes of illustrating one or more exemplary embodiments and not for purposes of limiting the same. FIG. 1 is a schematic view of an exemplary traffic scenario on roadways 100 according to an exemplary embodiment. The roadways 100 can include any type of path, road, highway, freeway, or travel route. The roadways 100 can have various configurations not shown in FIG. 1. The roadways 100 are traversed by one or more vehicles, such as a vehicle 102. The vehicle 102 is powered entirely or partially by rechargeable energy and may include one or more electric motors and/or by one or more electric batteries. In order to recharge, the vehicle 102 receives charge from an external source, such as the electrical grid.

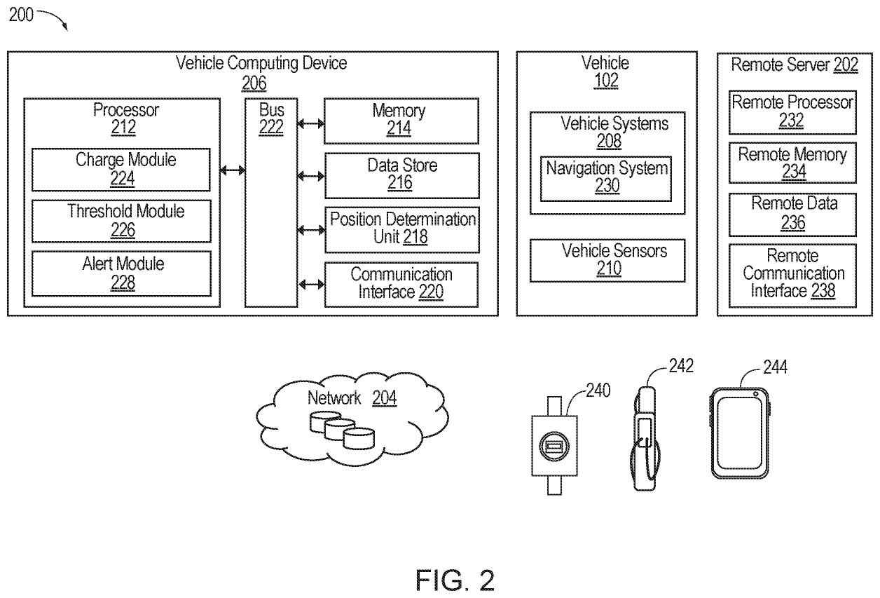

The roadways 100 illustrate paths the vehicle 102 can travel from a first location 104 to a second location 106. The locations include infrastructure for charging the vehicle 102. The first location 104 and the second location 106 may have access to the electrical grid, for example via a standard outlet, a wall charger unit, charging station such as the charging station 242 shown in FIG. 2, etc. in order to charge the vehicle 102. In some embodiments, the first location 104 is a residence of a user (not shown) and the second location 106 is a public area. For example, the second location 106 may be a retail outlet, public area, vacation home, a grocery store, and/or a work environment, such as an office, among others.

Charging information is stored for the first location 104 and the second location 106. The charging information is information about the energy usage at the first location 104 and/or the second location 106. The charging information may include a current measure and/or cumulative usage of energy in kilowatt hours (kWh) by the user. The charging information may also include different rates or tariffs for energy usage based on a current rate period or time of use period. A number of different rate periods and corresponding rates may be established based on demand, usage, time of day (e.g. peak rates and off-peak rates), day of the week, month, season, varying cost of supply or other factors. In one embodiment, the different rates may be arranged in tiers based on consumption levels such that the cost of energy increases with consumption. The charging information may be received or used by operating environment 200.

FIG. 2, a block diagram of the operating environment 200 for a charge consumption alert system according to an exemplary embodiment. One or more of the components of the operating environment 200 can be considered in whole or in part a vehicle communication network. The vehicle 102 communicates with a remote server 202 over a network 204. A vehicle computing device (VCD) 206 may be provided at the vehicle 102, the remote server 202, or other remote location operably connected to the vehicle 102 and/or the remote server 202 via the network 204. Vehicle systems 208 and vehicle sensors 210 communicate information about the vehicle 102 to the VCD 206.

Generally, the VCD 206 includes a processor 212, a memory 214, a data store 216, a position determination unit 218, and a communication interface 220, which are each operably connected for computer communication via a bus 222 and/or other wired and wireless technologies defined herein. The VCD 206, can include provisions for processing, communicating, and interacting with various components of the vehicle 102 and other components of the operating environment 200. In one embodiment, the VCD 206 can be implemented with the vehicle 102, for example, as part of a telematics unit, a head unit, an infotainment unit, an electronic control unit, an on-board unit, or as part of a specific vehicle control system, among others. In other embodiments, the VCD 206 can be implemented remotely from the vehicle 102, for example, with a portable device 244 or the remote server 202, connected via the network 204.

The processor 212 can include logic circuitry with hardware, firmware, and software architecture frameworks for remote control of the vehicle 102 by multiple operators. Thus, in some embodiments, the processor 212 can store application frameworks, kernels, libraries, drivers, application program interfaces, among others, to execute and control hardware and functions discussed herein. For example, the processor 212 can include a charge module 224, a threshold module 226, and an alert module 228 although it is understood that the processor 212 can be configured into other architectures. The memory 214 and/or the data store 216 may store data about the vehicle 102, such as the trip log data. Further, in some embodiments, the memory 214 and/or the data store 216 can store similar components as the processor 212 for execution by the processor 212.

The charge module 224, the threshold module 226, and the alert module 228 of the processor 212 may access the position determination unit 218 via the bus 222. The position determination unit 218 can include hardware (e.g., sensors) and software to determine and/or acquire position data about the vehicle 102. For example, the position determination unit 218 can include a global positioning system (GPS) unit (not shown) and/or an inertial measurement unit (IMU) (not shown). Thus, the position determination unit 218 can provide a geo-position of the vehicle 102 based on satellite data from, for example, a global position source (not shown), or from any Global Navigational Satellite infrastructure (GNSS), including GPS, Glonass (Russian) and/or Galileo (European). Further, the position determination unit 218 can provide dead-reckoning data or motion data from, for example, a gyroscope, accelerometer, magnetometers, among other vehicle sensors 210. In some embodiments, the position determination unit 218 can be a component of the navigation system 230 of the vehicle systems 208.

The communication interface 220 can include software and hardware to facilitate data input and output between the components of the VCD 206 and other components of the operating environment 200. Specifically, the communication interface 220 can include network interface controllers (not shown) and other hardware and software that manages and/or monitors connections and controls bi-directional data transfer between the communication interface 220 and other components of the operating environment 200 using, for example, the network 204. More specifically, in one embodiment, the VCD 206 can exchange data and/or transmit data, such as the charging information, with other operably connected devices or other communication hardware and protocols. Thus, the VCD 206 can exchange data with a user, utility, or the vehicle 102. In some embodiments, the vehicle 102 can also exchange data (e.g., charging information as will be described herein) over remote networks by utilizing the network 204 (e.g., a wireless communication network), or other wireless network connections.

The remote server 202 may include a remote processor 232 and/or a remote memory 234 that generate and/store charging information. In one embodiment, the charge module 224 may access the remote data 236, such as the charging information, via the remote communications interface 238. In one embodiment, the remote server 202 and/or the VCD 206 may be communicate with a utility company, government agency, service provider or other entity that receives charging information regarding monitoring and/or meter reading via the network 204. Accordingly, the remote server 202 and/or the VCD 206 may access, store, utilize, or transmit the charging information regarding the vehicle 102. Similarly, the remote server 202 and/or the VCD 206 may communicate with devices located at the first location 104 and/or the second location 106 via the network 204. The devices may include the electrical meter 240, the charging station 242, and/or the portable device 244.

Referring again to the vehicle 102, the vehicle systems 208 can include any type of vehicle control system and/or vehicle described herein to enhance the vehicle 102 and/or driving of the vehicle 102. Here, the vehicle systems 208 may include a navigation system 230. The navigation system 230 stores, calculates, and provides route and destination information and facilitates features like turn-by-turn directions. For example, the navigation system 230 may provide directions from the first location 104 to the second location 106.

The vehicle sensors 210, which can be implemented with the vehicle systems 208, can include various types of sensors for use with the vehicle 102 and/or the vehicle systems 208 for detecting and/or sensing a parameter of the vehicle 102, the vehicle systems 208, charging information, and/or the environment surrounding the vehicle 102. For example, the vehicle sensors 210 can provide charging information about the current charge state of the vehicle 102. The vehicle sensors 210 can include, but are not limited to: acceleration sensors, speed sensors, braking sensors, proximity sensors, vision sensors, ranging sensors, seat sensors, seat-belt sensors, door sensors, environmental sensors, yaw rate sensors, steering sensors, GPS sensors, among others. The vehicle sensors 210 can be any type of sensor, for example, acoustic, electric, environmental, optical, imaging, light, pressure, force, moisture, thermal, temperature, proximity, among others.

Using the system and network configuration discussed above, a personalized charge consumption alert may be generated for the vehicle 102. The systems and methods may determine that charging the vehicle 102 at a location will exceed an upper limit for a tiered rate and generate an alert for the user. Accordingly, an informed decision can be made as to where the vehicle 102 should be charged given the current usage. Detailed embodiments describing exemplary methods using the system and network configuration discussed above will now be discussed in detail.

### II. Methods for Providing a Charge Consumption Alert

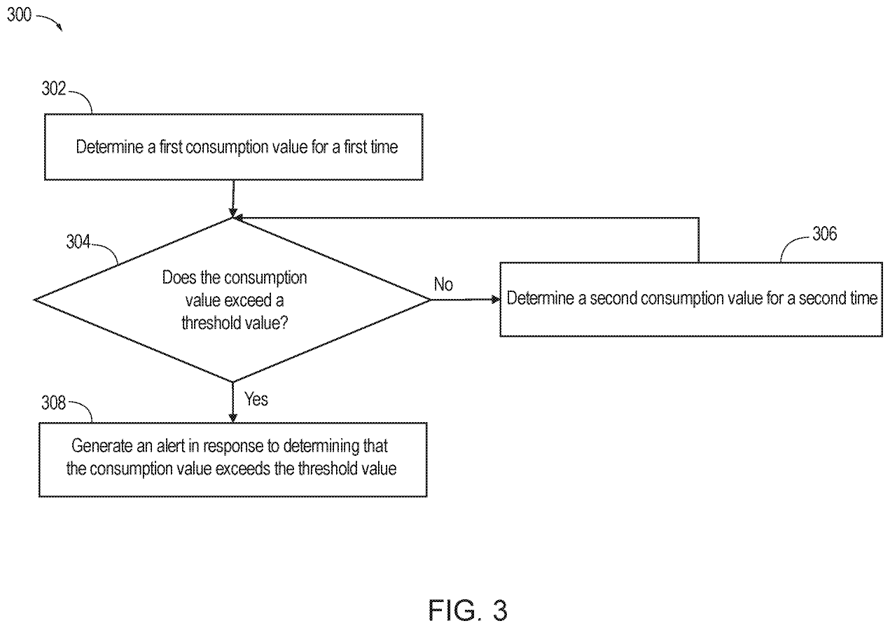

Referring now to FIG. 3, a method 300 for providing a charge consumption alert according to an exemplary embodiment. FIG. 3 will be described with reference to FIGS. 1, 2, and 4. As shown in FIG. 3, the method 300 can be described by a number of steps. For simplicity, the method 300 will be described by these steps, but it is understood that the steps of the method 300 can be organized into different architectures, blocks, stages, and/or processes.

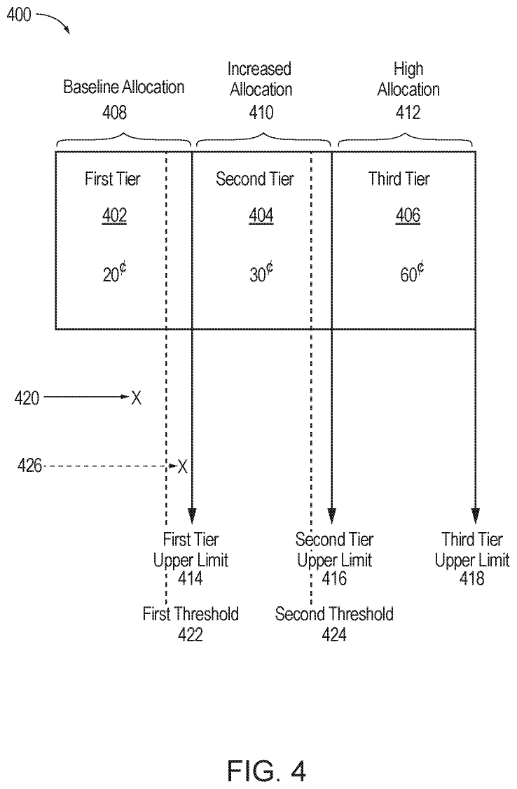

At block 302 the method 300 includes the charge module 224 determining a first consumption value 420, shown in FIG. 4, for a first time. Turning to FIG. 4, consumption values are determined with respect to a charge architecture, such as the exemplary charge architecture 400. In this manner, determining the first consumption value 420 also includes determining the corresponding tier of the charge architecture 400.

The charge architecture 400 includes a number of tiered charge levels that are associated with different costs for energy. For example, the first tier 402 may correspond to 20 cents per kWh, the second tier 404 may correspond to 30 cents per kWh, and the third tier 406 may correspond to 60 cents per kWh. In some embodiments, each tier of the charge architecture 400 corresponds to an amount of energy that can be consumed for the cost associated with that tier. Here, the first tier 402 corresponds to a baseline allocation 408. Accordingly, a user can consume the baseline allocation 408 amount of energy at a location at a rate of 20 cents per kWh. in the example given above, the first consumption value 420 is associated with the first tier 402.

The second tier 404 corresponds to an increased allocation 410 of energy that can be consumed at a rate of 30 cents per kWh. In some embodiments, the increased allocation 410 may be 101-400% of the baseline allocation 408. The third tier 406 corresponds to a high allocation 412 of energy that can be consumed at a rate of 60 cents per kWh. In some embodiments, the high allocation 412 may be ≥401% of the baseline allocation 408.

The tiers are divided by an upper limit of the preceding tier. For example, the first tier 402 is delineated from the second tier 404 by a first tier upper limit 414. The first tier upper limit 414 is 100% of the baseline allocation 408 of the first tier 402. The second tier 404 is delineated from the third tier 406 by a second tier upper limit 416. The second tier upper limit 416 is 100% of the increased allocation 410. Therefore, the second tier 404 is bounded by the first tier upper limit 414 and the second tier upper limit 416. A third tier upper limit 418 of the third tier 406 is 100% of the high allocation 412. Thus, the third tier 406 is bounded by the second tier upper limit 416 and the third tier upper limit 418.

In this manner, the charge architecture 400 defines the rate for energy in terms of tiers based on the amount of allowed consumption. The tiers of the charge architecture 400 can have various configurations not shown in FIG. 4. For example, the charge architecture 400 can have any number of tiers based on consumption, peak usage, rates, etc. Different locations may have different charge architectures. For example, the first location 104 may have the charge architecture 400, while the second location 106 may have a different charge architecture (not shown) with more or fewer tiers based on consumption, peak usage, rates, etc.

The first consumption value 420 reflects the current energy usage of the user at the first location 104. For example, the first consumption value may be 80% of the baseline allocation 408. Accordingly, the first consumption value 420 may indicate that the user is paying a rate for energy corresponding to the first tier 402. The consumption value 420 may indicate the current amount of energy consumption at the first location 104. Accordingly, the energy consumption may not be based wholly on energy consumed by the vehicle 102 but rather any consumption at the first location 104.

The energy consumption may be based on charging information from the remote server 202 including the remote data 236, the electrical meter 240, the charging station 242, and/or the portable device 244, among others. In another embodiment, the charge module 224 may determine the first consumption value 420 based on charging information from a utility company, government agency, service provider or other entity as described above. The charge module 224 may also access, query or receive the charging information from devices located at the first location 104 to determine the first consumption value 420. In another embodiment, the charge module 224 may calculate the first consumption value 420 based on the charging information from the vehicle 102. Additionally or alternatively, the first consumption value 420 may be predicted based on charging information from the past. Such historical charging information may be stored on the memory 214 and/or the data store 216 of the VCD 206 and/or remote memory 234 of the remote server 202.

At block 304 the method 300 includes the threshold module 226 determining whether a consumption value exceeds a threshold value. For example, the threshold module 226 may compare the first consumption value 420 to an upper limit of the current charge tier. Continuing the example from above, suppose first consumption value 420 is 80% of the baseline allocation 408 of the first tier 402. The first consumption value 420 would then be compared to a first threshold 422 also corresponding to the first tier 402. Conversely, if the first consumption value 420 fell in the increased allocation 410 of the second tier 404, then the first consumption value 420 would be compared to a second threshold 424 corresponding to the second tier 404.

The first threshold 422 and the second threshold 424 are indications that the user's energy consumption is approaching an upper limit for the corresponding tier. For example, the first threshold 422 indicates that the energy consumption is approaching the first tier upper limit 414 and the second threshold 424 indicates that the energy consumption is approaching the second tier upper limit 416. The thresholds, such as the first threshold 422 and the second threshold 424 may be any portion of the consumption corresponding to the tier.

The thresholds may be different and specific to the corresponding tier. For example, suppose the user consumes the baseline allocation 408 more quickly than the increased allocation 410. The first threshold 422 may be 95% of the first tier 402 since the user expects to consume the amount of energy represented by the first tier 402, whereas the second threshold 424 may be 75% of the second tier 404. Accordingly, the thresholds may be based on historical usage as well as other charging parameters (e.g., the amount of energy represented by the tier, the associated rate per kWh, user preferences, etc.).

The threshold module 226 compares the first consumption value 420 to the first threshold 422 to determine whether the first consumption value 420 exceeds the first threshold 422. If the first consumption value 420 does not exceed the first threshold 422, as shown in FIG. 4, the method 300 continues to block 306. At block 306 the charge module 224 determines a second consumption value 426 that reflects the usage of the user at a second time. The second time is later than a first time when the first consumption value 420 was determined. In this manner, the method 300 is iterative, such that charge module 224 is continually calculating consumption values that reflect the current usage of the user to determine if the user's energy consumption exceeds the threshold value.

If the first consumption value 420 does exceed the first threshold 422, the method 300 continues to block 308. At block 308 the method 300 includes the alert module 228 generating an alert in response to determining that the first consumption value 420 exceed a first threshold 422. The alert is a warning, notification, precaution, etc. that the usage is approaching or coming within a threshold amount of the upper limit of the corresponding tier. For example, the first consumption value 420 meeting or exceeding the first threshold 422 indicates that the energy consumption of the user is approaching the first tier upper limit 414. The alert module 228 may provide the alert to a portable device 244 and/or the vehicle 102. For example, the alert module 228 may provide the alert to a display screen (not shown) of the vehicle 102.

The alert may include the first consumption value 420 as well as charging information. The charging information may include the threshold value, historical usage data, and/or predictive data. For example, the alert may include a time estimate for reaching the upper limit of the current tier based on the trajectory of usage. The time estimate may also be based on historical usage. In this manner, the time estimate may be a predicted amount of time until the upper limit of the current tier is reached.

In another embodiment, the alert may include charging information specific to the vehicle 102. For example, given that the second consumption value 426 has exceeded the first threshold 422, the alert may indicate whether the vehicle 102 can be charged without exceeding the first tier upper limit 414. The charge module 224 may receive the current charge level of the vehicle 102 from the vehicle systems 208 and/or the vehicle sensors 210. Accordingly, the charge module 224 may determine the amount of energy that will be required to charge the vehicle 102. As one example, the charge module 224 may determine whether providing the vehicle 102 with a full charge at the first location 104 would cause the first tier upper limit 414 to be exceeded. The result may then be included in the alert.

The alert may also indicate a charging alternative at a different location. For example, the alert may indicate that the vehicle 102 can be charged at the second location 106. The alert may also include charging availability, an available charge start time, the predicted charge duration to charge the vehicle 102 at the second location 106, distance from the first location 104 to the second location 106, the travel time period, duration, and amenities (e.g., covered parking, access to a charge station 242, etc.), among others. The alert may also provide navigation information to the second location 106. Suppose that the alert is received at the vehicle 102. The navigation information may be sent to the navigation system 230 and a display (not shown) may provide the user with turn-by-turn directions to the second location 106.

The alert may also include incentives to charge at an alternative location. The incentives may be based on real-time vehicle data from the vehicle 102, for example, engagement/interaction with the vehicle 102 and location data of the vehicle 102. The incentive may be a draw to the second location 106. The incentive may have a monetary value. For example, suppose the second location 106 is retail store, the incentive may be a coupon or discount to services or goods at the second location 106. In another embodiment, the incentive may be points or improved status in a loyalty group should the vehicle be charged at the second location 106. The incentive may also be increased access to desired subject matter. For example, the incentive may unlock new features of software associated with the vehicle 102 if charged at the second location 106.

Therefore, the systems and methods provide charge consumption alerts that inform the user when the user may exceed a charge tier based on their own usage and charging information. Accordingly, the user can avoid increased fees for energy when charging the vehicle 102 based on the personalized consumption charge alert. The charge alert may also provide additional information such as an alternative location where the vehicle 102 can be charged as well as an incentive for using the second location 106. Based on the alert the user may decide to change the time or location at which the vehicle is charged. Thus, the user is provided the information and/or incentive needed to change their charging habits.

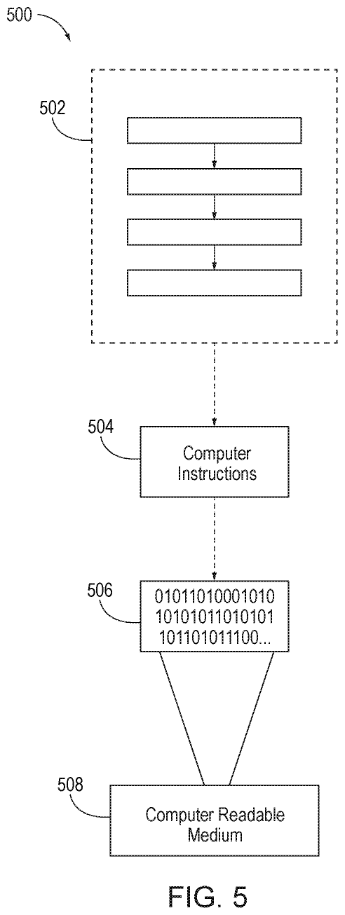

Still another aspect of the systems and methods provide charge consumption alerts involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein. In this implementation 500, the processor-executable computer instructions 504 may be configured to perform a method 502, such as the method 300 of FIG. 3. In another aspect, the processor-executable computer instructions 504 may be configured to implement a system, such as the operating environment of FIG. 2 and FIG. 4. Many such computer-readable media may be devised by those of ordinary skill in the art that are configured to operate in accordance with the techniques presented herein.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the VCD 206.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for a charge consumption alert, comprising:
a charge module configured to determine a first consumption value of a charge tier based on charge usage at a first location, wherein the charge tier has an upper limit;
a threshold module configured to determine whether the first consumption value exceeds a threshold value of the charge tier, wherein the threshold value is based on the upper limit; and
an alert module configured to generate an alert in response to determining that the first consumption value does exceed the threshold value, wherein the alert includes an incentive to charge a vehicle at a second location different than the first location.

2. The system of claim 1, wherein the charge module is further configured to determine an amount of energy to charge the vehicle, and wherein the alert includes an indication that charging the vehicle at the first location would exceed the upper limit.

3. The system of claim 1, wherein the charge module is configured to determine a second consumption value in response to determining that the first consumption value does not exceed the threshold value.

4. The system of claim 1, wherein the incentive is associated with a retail outlet at the second location.

5. The system of claim 1, wherein the alert includes navigation data to the second location.

6. The system of claim 1, wherein the first location is a residence, and the second location is a public place.

7. A method for providing a charge consumption alert, comprising:
determining a first consumption value of a charge tier for a vehicle based on charge usage at a first location, wherein the charge tier has a upper limit;
comparing the first consumption value to a threshold value of the charge tier, wherein the threshold value is based on the upper limit; and
generating an alert in response to determining that the first consumption value exceeds the threshold value, wherein the alert includes an incentive to charge the vehicle at a second location different than the first location.

8. The method of claim 7, further comprising:
determining the amount of energy required to charge the vehicle, and wherein the alert includes an indication that charging the vehicle at the first location would cause the upper limit to be exceeded.

9. The method of claim 7, further comprising:
determining a charge second consumption value in response to determining that the first consumption value does not exceed the threshold value.

10. The method of claim 7, wherein the threshold value is based on historical usage at the first location.

11. The method of claim 7, wherein the incentive includes a listing of amenities at the second location.

12. The method of claim 7, wherein the incentive is associated with a retail outlet at the second location.

13. The method of claim 7, wherein the alert includes navigation data to the second location.

14. The method of claim 7, wherein the first location is a residence, and the second location is a public place.

15. A non-transitory computer readable storage medium storing instructions that when executed by a computer, which includes a processor to perform a method for a charge consumption alert, the method comprising:
determining a first consumption value of a charge tier for a vehicle based on charge usage at a first location, wherein the charge tier has a upper limit;
comparing the first consumption value to a threshold value of the charge tier, wherein the threshold value is based on the upper limit; and
generating an alert in response to determining that the first consumption value exceeds the threshold value, wherein the alert includes an incentive to charge the vehicle at a second location different than the first location.

16. The non-transitory computer readable storage medium of claim 15, further comprising:
determining the amount of energy required to charge the vehicle, and wherein the alert includes an indication that charging the vehicle at the first location would cause the upper limit to be exceeded.

17. The non-transitory computer readable storage medium of claim 15, further comprising:
determining a charge second consumption value in response to determining that the first consumption value does not exceed the threshold value.

18. The non-transitory computer readable storage medium of claim 15, further comprising:
determining a charge second consumption value in response to determining that the first consumption value does not exceed the threshold value.

19. The non-transitory computer readable storage medium of claim 15, wherein the incentive is associated with a retail outlet at the second location.

20. The non-transitory computer readable storage medium of claim 15, wherein the alert includes navigation data to the second location.
